(19) United States
(12) Patent Application Publication
(10) Pub. No.: US 2018/0145303 A1
(43) Pub. Date: May 24, 2018

(54) Battery comprising a first battery cell and a second battery cell, and method for the electrical contacting of a first battery cell with a second battery cell, for the constitution of a battery

(71) Applicant: Robert Bosch GmbH, Stuttgart (DE)

(72) Inventors: Leonhard Ferdinand Schulz, Weil Der Stadt (DE); Martin Stoev, Stuttgart (DE); Robert Hafenbrak, Stuttgart (DE)

(21) Appl. No.: 15/819,113

(22) Filed: Nov. 21, 2017

(30) Foreign Application Priority Data
Nov. 23, 2016 (DE) 102016223187.1

(51) Int. Cl. H01M 2/20; H01M 10/0525

(52) U.S. Cl. CPC H01M 2/202; H01M 10/0525

(57) ABSTRACT

A battery (5) is disclosed comprising at least a first battery cell (10) and at least a second battery cell (60), wherein the first battery cell (10) and the second battery cell (60) are arranged one on top of the other in a first direction (7), wherein the first battery cell (10) comprises a plurality of projections (12-15) for the electrical connection of the first battery cell (10) with the second battery cell (60), wherein the projections (12-15) extend away from a first surface (19) of the first battery cell (10), essentially in the first direction (7), and wherein the second battery cell (60) comprises a plurality of recesses (62), for the accommodation of one of the projections (12-15) respectively,

wherein the arrangement of the projections (12-15) on the first battery cell (10) in the recesses (62) of the second battery cell (60) is such that the projections (12-15) with the recesses (62) respectively comprise a plurality of contact surfaces (30, 31) for the electrical connection of the first battery cell (10) with the second battery cell (60), characterized in that the contact surfaces (30, 31) are essentially oriented in parallel with the first direction (7).

### BACKGROUND OF THE INVENTION

The invention relates to a battery comprising a first battery cell and a second battery cell, and a method for the electrical contacting of a first battery cell with a second battery cell, for the constitution of a battery.

A variety of different batteries, each comprising a plurality of battery cells, are known. Previously known batteries have a disadvantage in that, in general, the connection of the individual battery cells is technically complex. In many cases, moreover, an additional connecting element is required for the mutual connection of the battery cells, in particular if a high-current connection between the battery cells is to be produced. Moreover, mechanical forces which generally occur during or after the connection of the battery cells can adversely affect the electrical connection between the battery cells.

### SUMMARY OF THE INVENTION

Forms of embodiment of the present invention can advantageously permit the provision of a generally technically simple and mechanically secure high-current connection between a plurality of battery cells in a battery, in particular in a lithium-ion battery.

According to a first aspect of the invention, a battery comprising at least a first battery cell and at least a second battery cell is proposed, wherein the first battery cell and the second battery cell are arranged one on top of the other in a first direction, wherein the first battery cell comprises a plurality of projections for the electrical connection of the first battery cell with the second battery cell, wherein the projections extend away from a first surface of the first battery cell, essentially in the first direction, and wherein the second battery cell comprises a plurality of recesses, for the accommodation of one of the projections respectively, wherein the arrangement of the projections on the first battery cell in the recesses of the second battery cell is such that the projections with the recesses respectively comprise a plurality of contact surfaces for the electrical connection of the first battery cell with the second battery cell, wherein the contact surfaces are essentially oriented in parallel with the first direction.

This has an advantage, in that the battery is generally provided with a technically simple high-current connection between the battery cells, wherein the high-current connection is mechanically secure. The battery customarily comprises a small number of individual components, such that the assembly of the battery can be executed rapidly. Moreover, a dissociation is provided in the vectoral direction and magnitude (strength) of the compression force applied for the mechanical connection of the battery cells (force applied in the first direction) and the force acting on the electrical contact surfaces in the normal direction (perpendicularly to the first direction), which determines the electrical transmission resistance between the battery cells, as these two forces are essentially oriented in a mutually perpendicular direction. The normal force of the electrical contacts or contact surfaces is generally perpendicular to the push-fit or press-fit force for the mechanical connection of the battery cells, which must be applied for the insertion or compression of the projections into the recesses. Customarily, by means of the plurality of projections and recesses, exceptionally high currents can flow. Customarily, moreover, the normal contact force of electrical contact between the projection and the recess, or between the battery cells, is oriented perpendicularly to the first direction (direction of the compression force for the mutual connection of the battery cells).

In general, the contact surfaces can in particular comprise the regions or surfaces in which the respective projection lies in direct contact with the respective recess. Via these contact surfaces, or by means of these contact surfaces, an electrical connection can generally be formed between the first battery cell and the second battery cell.

According to a second aspect of the invention, a method is proposed for the electrical contacting of a first battery cell with a second battery cell, for the constitution of a battery, comprising the following steps: provision of a first battery cell having a plurality of projections for electrical contacting with the second battery cell, the provision of a second battery cell having a plurality of recesses for the respective accommodation of one of the projections on the first battery cell; arrangement of the first battery cell and the second battery cell one on top of the other in a first direction; and the compression of the projections on the first battery cell into the recesses on the second battery cell in the first direction, such that mechanical contact surfaces oriented parallel to the first direction for the electrical connection of the first battery cell with the second battery cell are respectively formed between the projections and the recesses.

An advantage is provided in that, by this method, a battery can be produced which, in general, comprises a technically simple high-current connection between the battery cells, wherein the high-current connection is mechanically secure. The battery produced by this method customarily comprises a small number of individual components, such that the method can be executed rapidly. Moreover, the method provides a dissociation between the compression force applied for the mechanical connection of the battery cells (force applied in the first direction) and the force acting on the electrical contact surfaces, as these two forces are essentially oriented in a mutually perpendicular direction. The normal force of the electrical contacts or contact surfaces is generally perpendicular to the press-fit or push-fit force for the mechanical connection of the battery cells, which must be applied for the insertion or compression of the projections into the recesses. Customarily, in a battery produced by the method, by means of the plurality of projections and recesses, exceptionally high currents can flow. Customarily, moreover, the normal contact force of electrical contact between the projection and the recess, or between the battery cells, is oriented perpendicularly to the first direction (direction of the compression force for the mutual connection of the battery cells).

Ideas for forms of embodiment of the present invention can, inter alia, be considered to be based upon the considerations and findings described hereinafter.

In one form of embodiment, the projections are respectively configured with a star-shaped design in a cross-section, perpendicular to the first direction, and having teeth which are in particular rounded at their ends, wherein the projections are arranged in the recesses such that the ends of the teeth of the projections on the first battery cell, together with the surfaces of the recess which are contacted by the ends of the teeth, constitute the contact surfaces between the projection and the recess. By this arrangement, a large contact surface (equal to the sum of all the contact surfaces) can customarily be achieved. Accordingly, an exceptionally high current can flow in the connection between the first battery cell and the second battery cell. Moreover, the battery cells cannot generally be moved essentially relatively to each other, perpendicularly to the first direction. In general, an exceptionally secure electrical connection is provided accordingly.

In one form of embodiment, the recesses are respectively configured such that the recesses respectively assume the form of a perpendicular circular cylinder. This provides an advantage, in that the recesses can customarily be symmetrically configured or produced in a technically simple manner. Moreover, in general, an effective press-fit or push-fit can thus be achieved between the projections and the recesses. Moreover, in general, a broad region is available as a limit stop for the insertion of the projections into the recesses, thereby customarily ensuring the reliable prevention of damage during the insertion of the projections into the recesses.

In one form of embodiment, the projections are respectively arranged in the recesses such that, between the first battery cell and the second battery cell, in the first direction, a clearance is provided between the projection and the recess, at least in certain areas. By this arrangement, it is customarily ensured that, in each case, the projections can be deeply inserted into the recesses, such that the largest possible contact surfaces are formed between the projections and the recesses.

In one form of embodiment, the projections on the first battery cell, in particular mutually equidistantly, are arranged peripherally around an expansion region of the first battery cell, and the recesses in the second battery cell, in particular mutually equidistantly, are arranged peripherally around an expansion region of the second battery cell. By this arrangement, in general, a large space or a large volume is available, in which the battery cells, in particular lithium-ion cells, can expand or distend during electrical operation between various states of charge (SOC), without the application of mechanical forces or stresses between the battery cells. Thus, even in the event of the expansion or distension of the batteries, it is generally ensured that electrical connection is present, and the size of the contact surface essentially remains unchanged.

In one form of embodiment, the projections on the first battery cell are arranged in two mutually spaced first regions, and the recesses in the second battery cell are arranged in two mutually spaced second regions, wherein the expansion region of the first battery cell is configured between the first regions, and the expansion region of the second battery cell is configured between the second regions. By this arrangement, in general, an exceptionally large space or an exceptionally large volume is provided for the expansion or distension of the battery cells.

In one form of embodiment, the plurality of projections comprises at least ten, in particular at least twenty, and preferably at least fifty projections, and the plurality of recesses comprises at least ten, in particular at least twenty, and preferably at least fifty recesses. By means of the large number of projections and recesses, and the consequently exceptionally large contact surface, an exceptionally large current can generally flow in the connection. Moreover, an exceptionally secure mechanical connection, distributed over a large surface area, is generally achieved between the battery cells.

In one form of embodiment, the projections are configured integrally to the first battery cell and/or the recesses are configured integrally to the second battery cell. In a battery comprising more than two battery cells, e.g. three or four battery cells, both projections and recesses can generally be configured on each battery cell, in particular the internally-positioned battery cells of the battery, and in particular on opposing sides of the battery cell. The different respective electric potential-carrying design element (projection or recess) of the battery cell can typically be configured integrally. An advantage is thus provided, in that the battery can generally be produced in an exceptionally technically simple manner.

In one form of embodiment, the projections are configured with a mutually identical design and/or the recesses are configured with a mutually identical design. This generally simplifies the production of the battery. It is, moreover, advantageous, that little attention needs to be paid to the mutual orientation of the two cells during assembly, as the projections and the recesses are all of identical design. In general, this reduces the time required for the production of the battery.

The battery cell can customarily comprise one or more galvanic cells, which are essentially entirely enclosed by a battery housing, or by a plurality of battery housing sections, or by two battery housing half-shells. The battery housing sections or the battery housing half-shells can generally lie at different potentials.

It is hereby indicated that a number of the potential characteristics and advantages of the invention are described herein with reference to different forms of embodiment of the invention. A person skilled in the art will perceive that the characteristics can be combined, adapted or interchanged in an appropriate manner, in order to obtain further forms of embodiment of the invention.

### BRIEF DESCRIPTION OF THE DRAWINGS

Forms of embodiment of the invention are described hereinafter with reference to the attached drawings, wherein neither the drawings nor the description constitute any limitation of the invention.

FIG. 1 shows a cross-sectional view of a first form of embodiment of a battery according to the invention;

FIG. 2 shows a side view of the battery represented in FIG. 1;

FIG. 3 shows a perspective view of a battery cell of the battery represented in FIG. 1 or FIG. 2;

FIG. 4 shows a detailed view of region IV of the battery cell represented in FIG. 3;

FIG. 5 shows a further perspective view of the battery cell represented in FIG. 3;

FIG. 6 shows a detailed view of a projection on a battery cell of the battery represented in FIGS. 1-2;

FIG. 7 shows a detailed view of a recess in a battery cell of the battery represented in FIGS. 1-2;

FIG. 8 shows a further view of a projection on a battery cell of the battery represented in FIGS. 1-2;

FIG. 9 shows a perspective view of two individual battery cells in a further form of embodiment of the battery according to the invention; and

FIG. 10 shows a side view of a further form of embodiment of the battery according to the invention.

The figures are schematic only, and are not true to scale. In the figures, the same reference numbers represent identical characteristics, or characteristics having the same effect.

### DETAILED DESCRIPTION

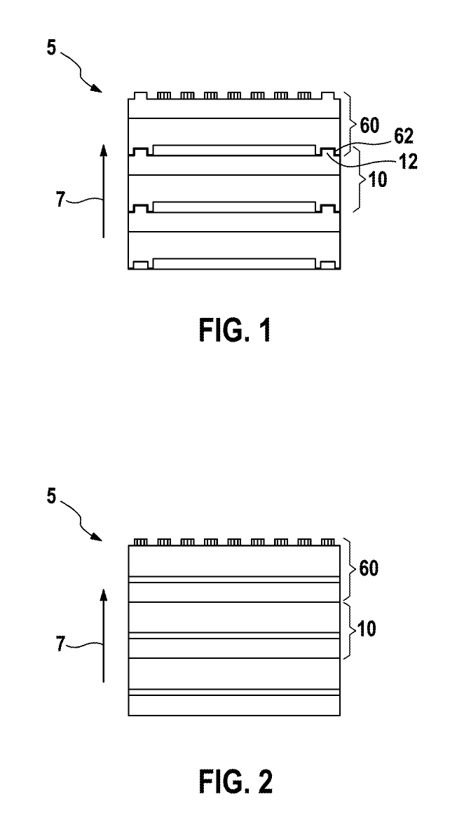

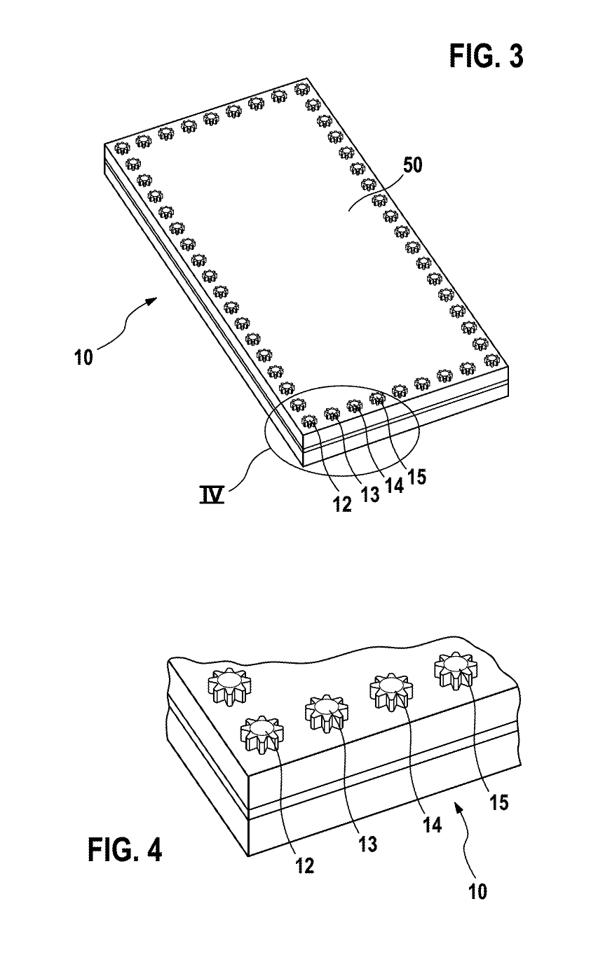

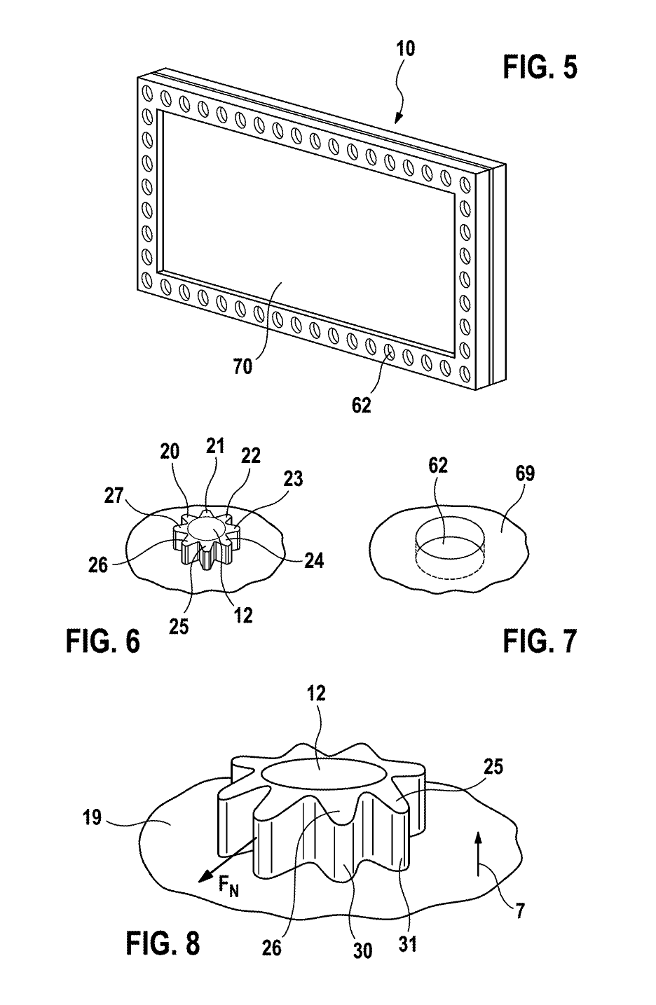

FIG. 1 shows a cross-sectional view of a first form of embodiment of the battery 5 according to the invention. FIG. 2 shows a side view of the battery 5 represented in FIG. 1. FIG. 3 shows a perspective view of a battery cell 10, 60 of the battery 5 represented in FIG. 1 or FIG. 2. FIG. 4 shows a detailed view of region IV of the battery cell 10, 60 represented in FIG. 3. FIG. 5 shows a further perspective view of the battery cell 10, 60 represented in FIG. 3.

The battery 5 comprises a plurality of battery cells 10, 60 which are connected in series. The battery 5 can in particular be a lithium-ion battery, which comprises a plurality of lithium-ion cells.

The cells or the battery cells 10, 60, in particular the first battery cell 10 and the second battery cell 60 of the battery 5, are arranged one on top of another in a first direction 7 (which, in FIG. 1, runs from bottom to top). The battery cells can be electrically interconnected in parallel or serially/in series. The battery cells 10, 60 are arranged with the same alignment, and the battery cells 10, 60 are offset in relation to each other in the first direction 7. A battery cell 10, 60 is thus modelled on the other battery cell 10, 60 by means of a pure translational displacement in the first direction 7. The battery cells 10, 60 are thus essentially oriented in a mutually parallel arrangement. In each case, the largest expansion of the battery cells 10, 60 is oriented perpendicularly to the first direction 7.

The battery 5 comprises three battery cells 10, 60. The number of battery cells 10, 60 can comprise two, four, five, six or more than six battery cells.

The first battery cell 10 comprises projections 12-15. The projections 12-15 project in the first direction 7 from a first surface 19 of the first battery cell 10, wherein the first surface 19 is oriented perpendicularly to the first direction 7. The projections 12-15 are arranged in the vicinity of the edge of the (in FIG. 3) upper plane or plane surface 19 of the first battery cell 10. The plurality of projections 12-15 are arranged such that, in combination, they peripherally enclose an expansion region 50 of the first battery cell 10. The projections 12-15 are arranged in a rectangle.

The second battery cell 60 comprises recesses 62. The recesses 62 are set back, in the first direction 7, from a second surface 69 of the second battery cell 60, which is oriented perpendicularly to the first direction 7. The recesses 62 are arranged in the vicinity of the edge of the (in FIG. 3) upper plane second surface 69 of the second battery cell 60. The plurality of recesses 62 are arranged such that, in combination, they peripherally enclose an expansion region 70 of the second battery cell 60. The recesses 62 are arranged in a rectangle.

The projections 12-15 on the first battery cell 10 are arranged in the recesses 62 of the second battery cell 60. In particular, in each recess 62 of the second battery cell 60, exactly one projection 12-15 on the first battery cell 10 can be arranged.

The number of projections 12-15 corresponds to the number of recesses 62. It is also conceivable that the number of recesses 62 provided exceeds the number of projections 12-15.

The first battery cell 10, on the side which is averted from the projections 12-15 or on the surface which is averted from the first surface 19, comprises recesses 62, and the second battery cell 60, on the side which is averted from the recesses 62 or on the surface which is averted from the second surface 69, comprises projections 12-15. The first battery cell 10 and the second battery cell 60 are thus of identical or equivalent design. As a result, a large number of battery cells, e.g. three, five or ten, can be arranged one on top of another, and electrically interconnected in series.

The recesses 62 customarily have a negative electrical potential (minus). The projections 12-15 generally have a positive electrical potential (plus). It is thereby ensured that a “plus” is always connected to a “minus”. However, it also conceivable for the recesses 62 to assume a positive electrical potential (plus), and for the projections 12-15 to assume a negative electrical potential (minus).

FIG. 6 shows a detailed view of a projection 12-15 on a battery cell 10 of the battery 5 represented in FIGS. 1-2. FIG. 7 shows a detailed view of a recess 62 in a battery cell 10 of the battery 5 represented in FIGS. 1-2. FIG. 8 shows a further view of a projection 12-15 on a battery cell 10 of the battery 5 represented in FIGS. 1-2.

In a cross-section perpendicular to the first direction 7 (i.e. a cross-section perpendicular to the drawing plane in FIG. 1 or FIG. 2) the projections 12-15 are respectively configured with a star-shaped design. The projection 12-15 comprises a circular cylindrical central section, from which teeth 20-27 or points project. The teeth 20-27 or points project from the central section in a regular arrangement. The circular cylindrical central section of the projection 12-15 comprises a slightly greater height (the height is oriented in the first direction 7) than the teeth 20-27 or points. The transition in height between the central section and the teeth 20-27 is configured continuously.

The ends 25 of the teeth 20-27 or points of the star shape of the projection 12-15 are rounded. Each of the recesses 62 is of circular cylindrical design. The diameter of the circular cylinder of the recess 62 essentially corresponds to the diameter of the projection 12-15, from one point to an opposing point. Accordingly, a press-fit or a push-fit of the projection 12-15 in the recess 62 can be achieved.

The projections 12-15 are oriented with rotational symmetry to an axis which runs through the center of the projection 12-15, in FIG. 1 from top to bottom, or in the first direction 7. The number of teeth 20-27 or points on the projection 12-15 is eight. A different number of teeth 20-27 or points is conceivable, e.g. two, three, four, five, six, seven, nine or ten teeth 20-27. A greater number than ten teeth is also conceivable.

Shapes other than a star shape for the projections 12-15 are also conceivable. It is important that each projection 12-15 should contact the respective recess 62 at a plurality of points. The greater the contact surface 30, 31 per projection 12-15 or recess 62, and the greater the number of projections 12-15 or recesses 62, the greater the total surface area of the contact surfaces 30, 31 will be, thus permitting the maximum possible current flow from the first battery cell 10 to the second battery cell 60.

The projections 12-15 on the first battery cell 10 are inserted or pressed into the recesses 62 on the second battery cell 60 in the first direction 7, by the application of pressure. Accordingly (in a direction perpendicular to the first direction 7) a non-slip mechanical connection is achieved between the first battery cell 10 and the second battery cell 60. The ends 25 of the teeth 20-27 or points of the projections 12-15, further to the insertion or compression of the projections 12-15 into the recesses 62, contact the recesses 62 on a plurality of contact surfaces 30, 31. The contact surfaces 30, 31 are those regions or areas in which the respective projection 12-15 lies in direct contact with the respective recess 62. Via these contact surfaces 30, 31, or by means of these contact surfaces 30, 31, an electrical connection is formed between the first battery cell 10 and the second battery cell 60.

Each of the contact surfaces 30, 31 is oriented in parallel with the first direction 7. In particular, the term “essentially parallel” can also in particular imply the existence of an angle smaller than approximately 1°, than approximately 2°, than approximately 5°, or than approximately 10° between the contact surface 30, 31 and the first direction.

The sum of the contact surfaces 30, 31 between the first battery cell 10 and the second battery cell 60 is relatively high, such that a high current can flow through the connection.

The depth of the recess 62 is (somewhat) greater than the height of the projection 12-15, such that the projection 12-15, even in the event of minor deviations or tolerances, can be fully-inserted into the recess 62, thus permitting the contact surface 30, 31 or contact surfaces 30, 31 of equal size to be maintained at all times.

The force for the mechanical connection of the first battery cell 10 with the second battery cell 60 is applied or oriented in the first direction 7, or along the first direction 7. The force associated with the weight of the battery cells 10, 60 is oriented in opposition to the first direction 7. In each case, the normal force of the contact surfaces 30, 31 is oriented perpendicularly to the first direction 7. In each case, the projections 12-15 or the ends of the points/teeth 20-27 of the projections 12-15 are compressed against the inner surface of the recesses 62 in a direction which is essentially perpendicular to the first direction 7.

The force which ensures the electrical connection of the first battery cell 10 with the second battery cell 60 is thus oriented at an angle of approximately 90° to the weight force, and at an angle of approximately 90° to the force which must be applied for the mechanical connection of the battery cells 10, 60, or for the insertion/compression of the projections 12-15 into the recesses 62. The force which must be applied for the mechanical connection of the battery cells 10, 60, or for the insertion/compression of the projections 12-15 into the recesses 62, and the weight force are oriented in the same direction, or are mutually parallel.

In particular, all the contact surfaces 30, 31 between the projections 12-15 on the first battery cell 10 and the recesses 62 in the second battery cell 60 have an essentially parallel orientation to the first direction 7. This means that any vector which, at any point on the contact surface 30, 31, is normal to the contact surface 30, 31 is oriented perpendicularly to the first direction 7.

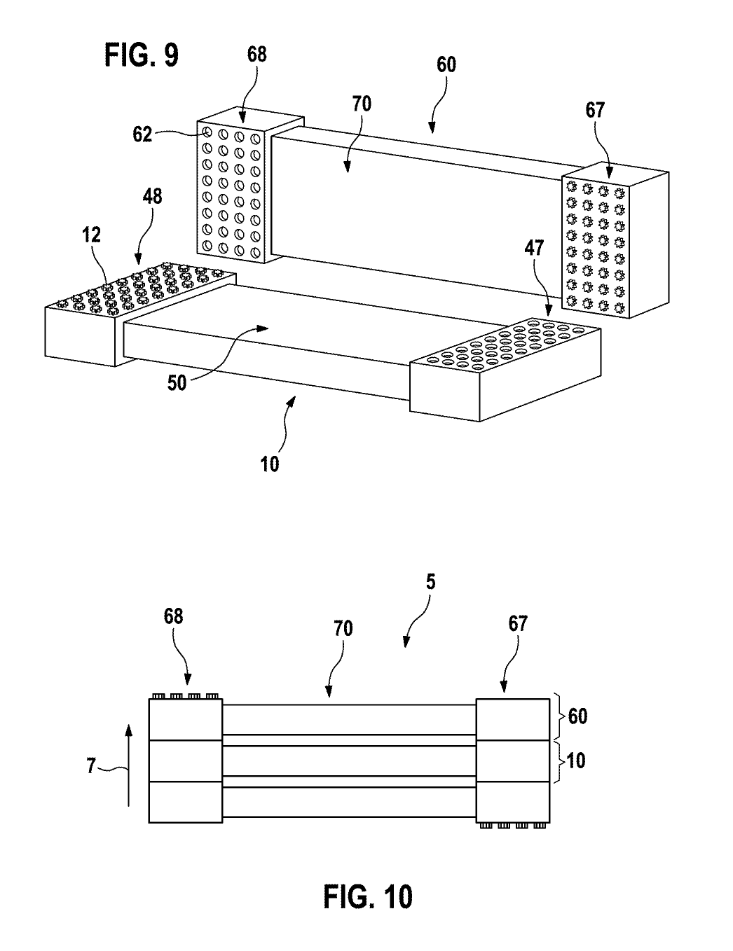

FIG. 9 shows a perspective view of two individual battery cells 10, 60 in a further form of embodiment of the battery 5 according to the invention. FIG. 10 shows a side view of a further form of embodiment of the battery 5 according to the invention.

The battery cells 10, 60 represented in FIG. 9, and the further form of embodiment of the battery 5 represented in FIG. 10 essentially differ from the battery cell represented in FIGS. 3-4 or from the form of embodiment of the battery 5 represented in FIGS. 1-2 with respect to the position and the arrangement of the projections 12-15 and the recesses 62. The projections 12-15 on the first battery cell 10 are arranged in two mutually separated or spaced first regions 47, 48. Between the first regions 47, 48 a first expansion region 50 of the first battery cell 10 is arranged. The recesses 62 in the second battery cell 60 are arranged in two mutually separated or spaced second regions 67, 68. Between the second regions 67, 68, a second expansion region 70 of the second battery cell 60 is arranged.

In the first regions 47, 48 and in the second regions 67, 68, the projections 12-15 or recesses 62 are arranged mutually equidistantly in a grid-like pattern.

From the arrangement or connection of the battery cells 10, 60 represented in FIG. 10, it thus proceeds that the first expansion region 50 is positioned entirely below the second expansion region 70. This also applies to the expansion regions of further battery cells. The expansion regions 50, 70 are respectively of a planar or flat design. The surfaces of the expansion regions 50, 70 are essentially oriented perpendicularly to the first direction 7.

In the expansion regions 50, 70, the battery cells 10, 60 are arranged with a mutual clearance. A large volume is thereby formed, into which the battery cell 10, 60 can expand respectively, without the occurrence of mechanical stresses between the battery cells 10, 60, or even the impairment or detachment of the mechanical connection, and consequently of the electrical connection.

The battery cells 10, 60 can be primary cells (non-rechargeable) and/or secondary cells (rechargeable).

In conclusion, it should be observed that terms such as “having”, “comprising” etc. do not exclude any further elements or steps, and terms such as “a” or “an” do not exclude the plural. Reference symbols in the claims are not to be considered as a limitation.

1. A battery (5) comprising
at least a first battery cell (10) and at least a second battery cell (60),
wherein the first battery cell (10) and the second battery cell (60) are arranged one on top of the other in a first direction (7),
wherein the first battery cell (10) comprises a plurality of projections (12-15) for electrical connection of the first battery cell (10) with the second battery cell (60), wherein the projections (12-15) extend away from a first surface (19) of the first battery cell (10), essentially in the first direction (7),
and wherein the second battery cell (60) comprises a plurality of recesses (62), for receipt of respective projections (12-15),
wherein the receipt of the projections (12-15) on the first battery cell (10) in the recesses (62) of the second battery cell (60) is such that the projections (12-15) with the recesses (62) respectively comprise a plurality of contact surfaces (30, 31) for the electrical connection of the first battery cell (10) with the second battery cell (60),
characterized in that
the contact surfaces (30, 31) are essentially oriented in parallel with the first direction (7).

2. The battery (5) according to claim 1,
wherein the projections (12-15) are respectively configured with a star-shaped design in a cross-section, perpendicular to the first direction (7), and having teeth (20-27) with respective ends (25), and
wherein the projections (12-15) are arranged in the recesses (62) such that the ends (25) of the teeth (20-27) of the projections (12-15) on the first battery cell (10), together with the surfaces of the recess (62) which are contacted by the ends (25) of the teeth (20-27), constitute the contact surfaces (30, 31) between the projection (12-15) and the recess (62).

3. The battery (5) according to claim 1, wherein the recesses (62) are respectively configured such that the recesses (62) respectively assume the form of a perpendicular circular cylinder.

4. The battery (5) according to claim 1, wherein the projections (12-15) are respectively arranged in the recesses (62) such that, between the first battery cell (10) and the second battery cell (60), in the first direction (7), a clearance is provided between the projection (12-15) and the recess (62), at least in certain areas.

5. The battery (5) according to claim 1, wherein the projections (12-15) on the first battery cell (10), are arranged peripherally around an expansion region (50) of the first battery cell (10), and the recesses (62) in the second battery cell (60) are arranged peripherally around an expansion region (70) of the second battery cell (60).

6. The battery (5) according to claim 5, wherein the projections (12-15) on the first battery cell (10) are arranged in two mutually spaced first regions (47, 48), and the recesses (62) in the second battery cell (60) are arranged in two mutually spaced second regions (67, 68), wherein the expansion region (50) of the first battery cell (10) is configured between the first regions (47, 48), and the expansion region (70) of the second battery cell (60) is configured between the second regions (67, 68).

7. The battery (5) according to claim 1, wherein the plurality of projections (12-15) comprises at least ten projections, and the plurality of recesses (62) comprises at least ten recesses.

8. The battery (5) according to claim 1, wherein the projections (12-15) are configured integrally to the first battery cell (10) and/or the recesses (62) are configured integrally to the second battery cell (60).

9. The battery (5) according to claim 1, wherein the projections (12-15) are configured with a mutually identical design and/or the recesses (62) are configured with a mutually identical design.

10. A method for the electrical contacting of a first battery cell (10) with a second battery cell (60), for the constitution of a battery (5), comprising the following steps:
providing a first battery cell (10) having a plurality of projections (12-15) for electrical contacting with the second battery cell (60),
providing a second battery cell (60) having a plurality of recesses (62) for respective accommodation of one of the projections (12-15) on the first battery cell (10);
arranging the first battery cell (10) and the second battery cell (60) one on top of the other in a first direction (7); and
compressing the projections (12-15) on the first battery cell (10) into the recesses (62) on the second battery cell (60) in the first direction (7), such that mechanical contact surfaces (30, 31) oriented parallel to the first direction (7) for the electrical connection of the first battery cell (10) with the second battery cell (60) are respectively formed between the projections (12-15) and the recesses (62).

11. The battery (5) according to claim 1, wherein the projections (12-15) are respectively configured with a star-shaped design in a cross-section, perpendicular to the first direction (7), and having teeth (20-27) which are rounded at their ends (25), and wherein the projections (12-15) are arranged in the recesses (62) such that the ends (25) of the teeth (20-27) of the projections (12-15) on the first battery cell (10), together with the surfaces of the recess (62) which are contacted by the ends (25) of the teeth (20-27), constitute the contact surfaces (30, 31) between the projection (12-15) and the recess (62).

12. The battery (5) according to claim 1, wherein the projections (12-15) on the first battery cell (10) are mutually equidistantly arranged peripherally around an expansion region (50) of the first battery cell (10), and the recesses (62) in the second battery cell (60) are mutually equidistantly arranged peripherally around an expansion region (70) of the second battery cell (60).

13. The battery (5) according to claim 1, wherein the plurality of projections (12-15) comprises at least twenty projections, and the plurality of recesses (62) comprises at least twenty recesses.

14. The battery (5) according to claim 1, wherein the plurality of projections (12-15) comprises at least fifty projections, and the plurality of recesses (62) comprises at least fifty recesses.
